(19) United States
(12) Patent Application Publication
(10) Pub. No.: US 2009/0021942 A1
(43) Pub. Date: Jan. 22, 2009

(54) LAMP ASSEMBLY

(75) Inventor: Hak-Bong Kim, Gyeongsan (KR)

Correspondence Address: EDWARDS ANGELL PALMER & DODGE LLP, P.O. BOX 55874, BOSTON, MA, 02205, US

(73) Assignee: SL CORPORATION, Daegu (KR)

(21) Appl. No.: 12/176,922

(22) Filed: Jul. 21, 2008

(30) Foreign Application Priority Data
Jul. 20, 2007 (KR) 10-2007-0072855

(51) Int. Cl. F21S 8/00

(52) U.S. Cl. 362/268

(57) ABSTRACT

A headlamp for a vehicle is provided. The headlamp includes a light source, a reflector reflecting and condensing light emitted from the light source, a first lens refracting and radiating the light emitted from the light source in a forward direction, a shielding device that is disposed between the light source and the first lens and shields some of the light emitted from the light source, and a second lens that is disposed between the first lens and the shielding device and changes a light path by refracting light before being incident on the first lens.

### CROSS-REFERENCE TO RELATED APPLICATION

This application claims priority from Korean Patent Application No. 10-2007-0072855 filed on Jul. 20, 2007, the disclosure of which is incorporated herein by reference in its entirety.

### BACKGROUND

1. Technical Field

The present invention relates to a headlamp for a vehicle, and more particularly, to a projection-type headlamp assembly for a vehicle, which provides different beam patterns according to a vehicle traveling environment.

2. Background Art

A vehicle headlamp system, generally known as a front lighting system, illuminates the roadway in front of a vehicle. Conventional vehicle headlamps are designed to provide a driver with a fixed beam pattern regardless of variably changing road conditions. Recently, to overcome this drawback and provide a driver with visibility suitable for various road conditions, an Adaptive Front Lighting System (AFLS) has been developed that optimizes beam patterns according to road and ambient conditions that continuously vary during vehicle travel.

FIG. 1 is a schematic view illustrating a construction of a general projection-type headlamp.

Referring to FIG. 1, the general projection-type headlamp includes a light source 10, a hemispherical reflector 20 reflecting and condensing light emitted from the light source 10, an aspheric lens 30 refracting light emitted from the light source 10 in a forward direction of a vehicle, and a lamp shield 40 shielding some of the emitted light. The general projection-type headlamp further includes a signal plate 41 that is fixed to a top end of the lamp shield 40 and reflects light reflected by the reflector 20 so that it is incident at an upper portion of the aspheric lens 30.

Unlike a clear-type headlamp, the general projection-type headlamp having the above-mentioned construction can provide various beam patterns by changing the shape of the top end of the lamp shield 40 or rotating or horizontally moving the lamp shield 40, because light reflected by the reflector 20 is condensed at the top end of the lamp shield 40, which is a focus of the reflector 20. Further, the general projection-type headlamp has the signal plate 41 that allows the light reflected by the reflector 20 to be incident at the upper portion of the aspheric lens 30, thereby providing nighttime visibility in front of a vehicle so that objects, such as road signs, can be distinguished.

According to the general projection-type headlamp, however, since the signal plate 41 is fixed to the lamp shield 40, it is quite difficult to meet all signal laws and regulations depending on different beam patterns, which may be achieved by horizontally moving or rotating the lamp shield.

Another drawback is that use of the signal plate 41 causes a loss in the light intensity of a horizontal portion of a beam pattern, as indicated by \textcircled{1} in FIG. 2, thereby making it difficult to ensure a vehicle's forward visibility of a road at nighttime.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a lamp assembly, which can provide a driver with optimized visibility suitable for different road conditions by adaptively changing beam patterns according to road and ambient conditions that vary continuously during vehicle travel.

The present invention also provides a lamp assembly that can satisfy all signal laws and regulations depending on different beam patterns achieved by an Adaptive Front Lighting System (AFLS).

The present invention also provides a lamp assembly which can improve horizontal visibility and remote-area visibility for nighttime drivers.

According to an aspect of the present invention, there is provided a lamp assembly including a light source, a reflector reflecting and condensing light emitted from the light source, a first lens refracting and radiating the light emitted from the light source in a forward direction, a shielding device that is disposed between the light source and the first lens and shields some of the light emitted from the light source, and a second lens that is disposed between the first lens and the shielding device and changes a light path by refracting light before being incident on the first lens.

The above and other objects of the present invention will be described in and be apparent from the following description of preferred embodiments.

### BRIEF DESCRIPTION OF THE DRAWINGS

The above and other features and advantages of the present invention will become more apparent in the detailed description of the preferred embodiments thereof with reference to the attached drawings in which:

FIG. 1 is a schematic view illustrating a construction of a general projection-type headlamp;

FIG. 2 illustrates a beam pattern produced by the headlamp of FIG. 1;

FIG. 3 is a perspective view of a lamp assembly according to an embodiment of the present invention;

FIG. 4 is an exploded perspective view of the lamp assembly illustrated in FIG. 3;

FIG. 5A is an enlarged perspective view of the signal lens illustrated in FIGS. 3 and 4;

FIG. 5B is a plan view of the signal lens of FIG. 5A;

FIG. 5C is a cross-sectional view of FIG. 5A taken along line V-V;

FIG. 6 is a schematic view illustrating a construction of the lamp assembly illustrated in FIG. 3;

FIG. 7 is a view for explaining upward guiding of a light path by a signal lens according to the present invention;

FIG. 8 is a view for explaining the change of a light path due to a refractive index difference between air and a signal lens according to the present invention;

FIGS. 9A through 9C illustrate beam patterns produced by a lamp assembly according to the present invention; and

FIGS. 10A and 10B illustrate comparison of road visibility between the conventional headlamp using a signal plate and a headlamp using a signal lens according to the present invention.

### DETAILED DESCRIPTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure is thorough and complete, and fully conveys the concept of the invention to those skilled in the art. The present invention will only be defined by the appended claims. Like reference numerals refer to like elements throughout the specification.

Hereinafter, a lamp assembly according to a preferred embodiment of the present invention will be described in detail with reference to the accompanying drawings, and a detailed explanation thereof is not given so as not to unnecessarily obscure aspects of the present invention.

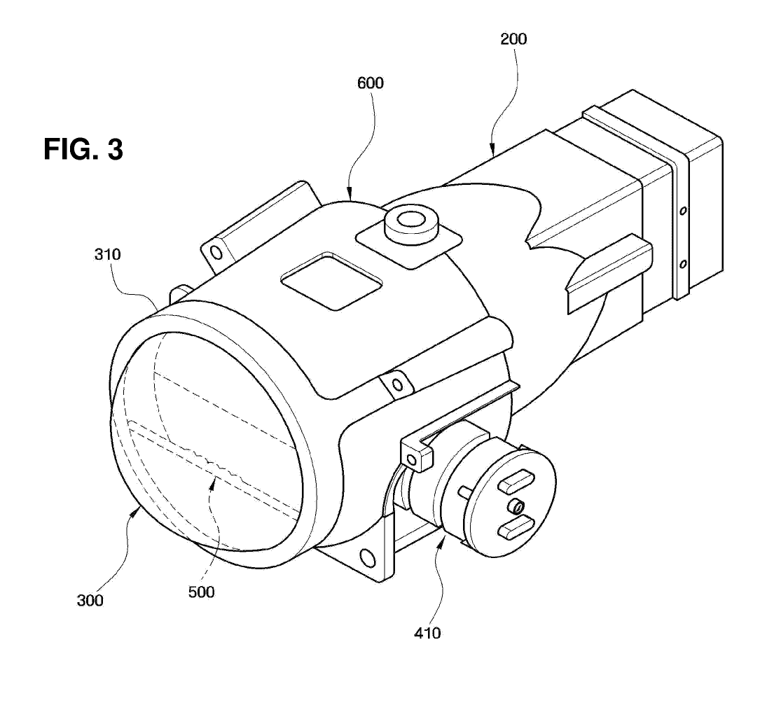

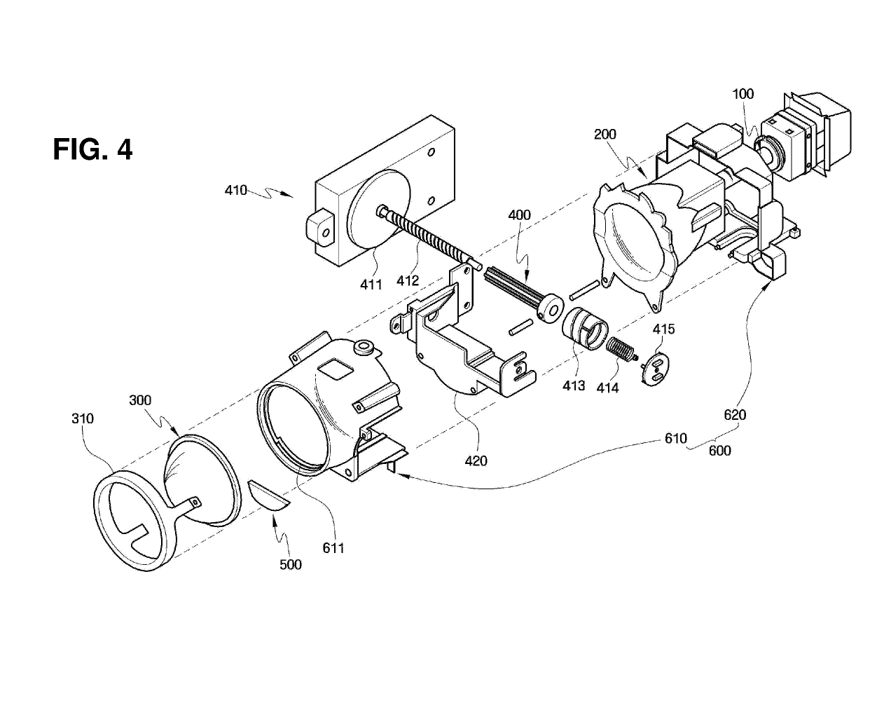

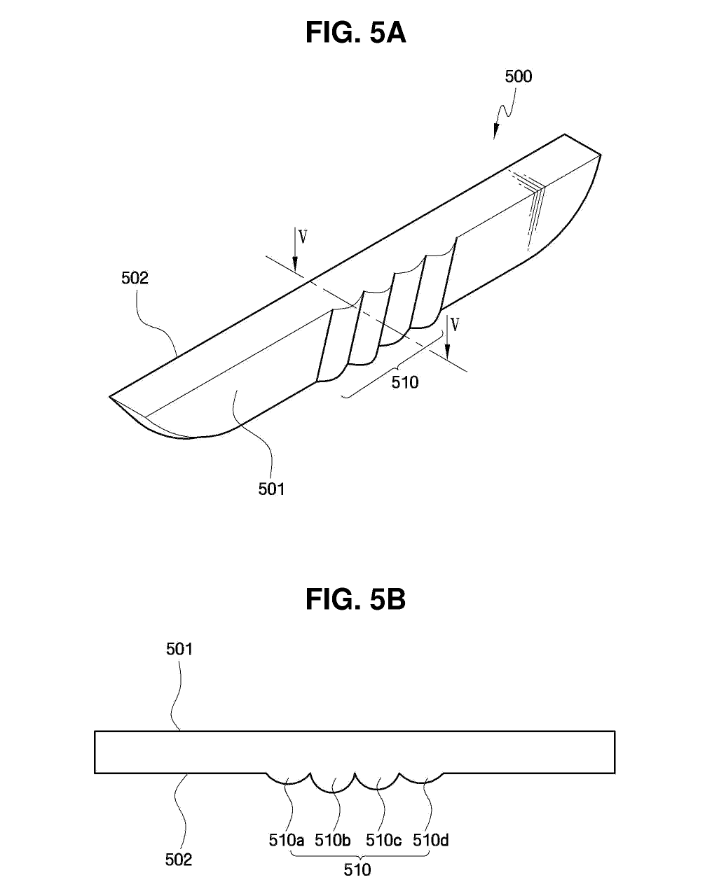

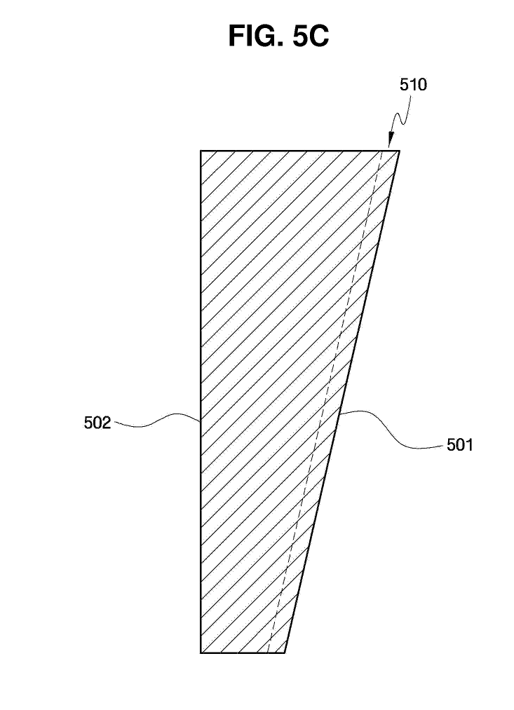

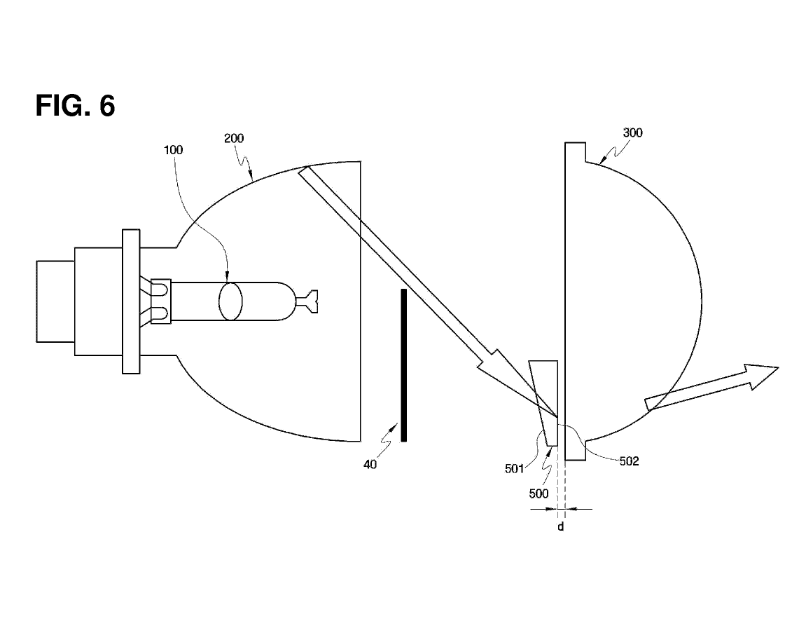

FIG. 3 is a perspective view of a lamp assembly according to an embodiment of the present invention, FIG. 4 is an exploded perspective view of the lamp assembly illustrated in FIG. 3, FIG. 5A is an enlarged perspective view of the signal lens illustrated in FIGS. 3 and 4, FIG. 5B is a plan view of the signal lens of FIG. 5A, FIG. 5C is a cross-sectional view of FIG. 5A taken along line V-V, and FIG. 6 is a schematic view illustrating a construction of the lamp assembly illustrated in FIG. 3.

Referring to FIGS. 3 through 6, a vehicle headlamp assembly according to an embodiment of the present invention includes a light source 100, a reflecting device 200, a first lens 300, a shielding device 400, a second lens 500, and a housing 600. The vehicle headlamp assembly according to the present embodiment may be a projection-type headlamp that focuses light emitted from the light source 100 at one point. The projection-type headlamp has excellent light distribution over a general clear-type headlamp and gives a front of a vehicle a sporty appearance.

The light source 100 provides light for illuminating a roadway in front of a vehicle. The light source 100 may be a general high-intensity discharge (HID) lamp, a halogen lamp, or light-emitting diode (LED). The light source 100 is located at a first focus of the reflector 200.

The reflecting device 200 is a reflector having a predetermined shape such as a hemispherical shape (hereinafter called a “reflector 200”). The reflector 200 reflects light emitted from the light source 100 in the forward direction and condenses the light. The reflector 200 has an inner reflective surface with a highly reflective coating layer deposited thereon. The highly reflective coating layer may be formed of aluminum (Al) or silver (Ag).

The first lens 300 is a general aspheric lens having a predetermined refractive index (hereinafter referred to as an “aspheric lens 300”) The aspheric lens 300 is fitted to a front surface of the housing 600 by a fixed rib 310, and refracts and radiates light emitted from the light source 100 in a front lighting direction. The aspheric lens 300 has a planar light incident surface and a convex light exit surface.

The shielding device 400 is a lamp shield that is disposed between the light source 100 and the aspheric lens 300 and shields some of the light emitted from the light source 100 (hereinafter called a “lamp shield 400”). More specifically, except for when a high beam is irradiated, the lamp shield 400 shields light that is emitted downward from the light source 100 and reflected by the reflector 200 so as to travel upward, thereby preventing the light from causing discomfort that irritates the eyes of other drivers. The lamp shield 400 is disposed at a second focus of the reflector 200 that is a focus of the aspheric lens 300. In the present embodiment, the lamp shield 400 protrudes from an outer circumference of a cylinder that is positioned to intersect a light path at a predetermined height in an axial direction and is rotated or moved horizontally by a shield driving unit 410. The lamp shield 400 may have various other shapes and can be fixed within the housing 600. The shield driving unit 410 has a known construction including a driving motor 411, a cylinder 413, an elastic member 414, and a fixed piece 415. The lamp shield 400 and the shield driving unit 410 are mounted within a fixed bracket 420.

The second lens 500 is a signal lens having a predetermined refractive index that is disposed between the aspheric lens 300 and the lamp shield 400 (hereinafter called a “signal lens 500”), and primarily refracts light from the light source 100. The signal lens 500 is a medium denser than the air in the gap between the light source 100 and the aspheric lens 300. That is, the signal lens 500 has a refractive index Ns greater than that of air (Na=1). Preferably, the refractive index Ns is 1.47. The signal lens 500 is spaced apart from the aspheric lens 300 by a predetermined distance d, for example, by about 0.5 mm to about 1 mm. The signal lens 500 may be fitted in a fixed recess 611 that is formed in one side of a front aperture in a front housing 610 having the aspheric lens 300 fitted thereto. While, in the present embodiment, the signal lens 500 is located behind a lower portion of the aspheric lens 300, it may be located behind an upper portion or both upper and lower portions of the aspheric lens 300. The signal lens 500 has a thickness that increases toward the top thereof. The signal lens 500 also has a light incident surface 501 inclined downward and a light exit surface 502 parallel to a rear surface of the aspheric lens 300. The signal lens 500 includes a light intensity compensator 510 that compensates for the loss in horizontal light intensity radiating forward from the aspheric lens 300.

The light intensity compensator 510 includes a plurality of concave or convex curved surfaces 510a through 510d with different radii of curvature, which are formed in a center of the light incident surface 501 of the signal lens 500. The plurality of curved surfaces 510a through 510d may have different radii of curvature depending on the degree of compensation for horizontal light intensity. For example, among the plurality of curved surfaces 510a through 510d, one curved surface requiring a higher degree of compensation for horizontal light intensity preferably has a larger radius of curvature than the others. The plurality of curved surfaces 510a through 510d may be horizontally or vertically parallel to one another. While, in the present embodiment, the light intensity compensator 510 is formed integrally with the signal lens 500, it may be formed as a separate element and affixed to the signal lens 500.

The housing 600 includes front and rear housings 610 and 620 connected to each other. The aspheric lens 300 and the reflector 200 are respectively fitted to the front and rear of the housing 600. The housing 600 accommodates the light source 100, the signal lens 500, the lamp shield 400, and the shield driving unit 410 therein.

In the vehicle headlamp assembly having the above-mentioned construction, light emitted from the light source 100 is reflected by the reflector 200, and condensed in front of the light source 100. Light emitted upward from the light source 100 propagates downward, while light emitted downward from the light source 100 is reflected by the reflector 200 so that it travels upward. More specifically, except for when a high beam is irradiated, the lamp shield 400 shields the light that is emitted downward from the light source 100 and travels upward so that the light does not cause glare discomfort which may irritate the eyes of other drivers. The light that is emitted upward from the light source 100 and propagates downward is then double-refracted upward as it is sequentially transmitted through the signal lens 500 and the aspheric lens 300. In this case, the vehicle lamp assembly can meet all signal laws and regulations depending on different beam patterns achieved by an Adaptive Front Lighting System (AFLS) by rotating or horizontally moving the lamp shield 400.

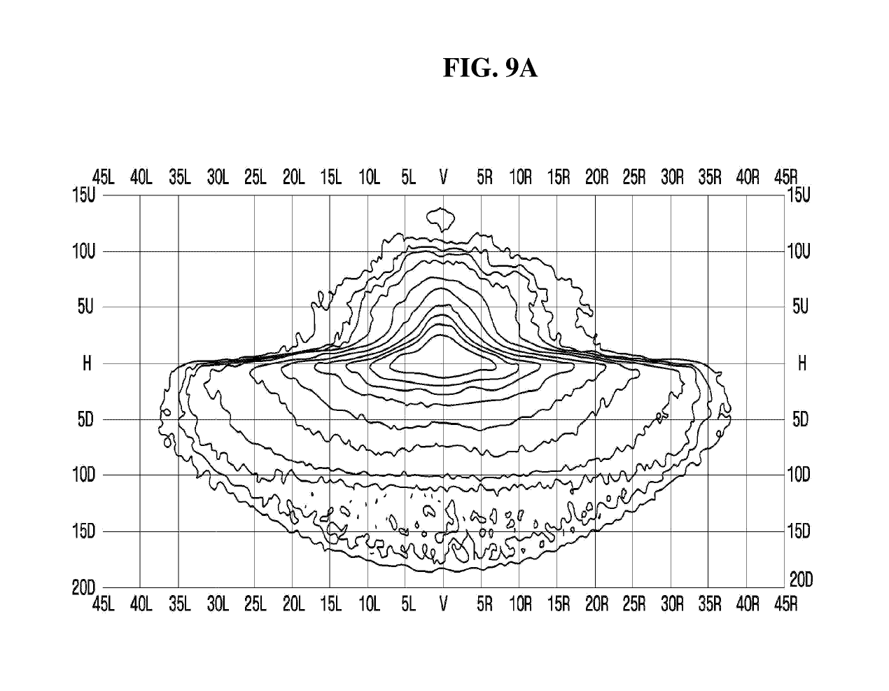

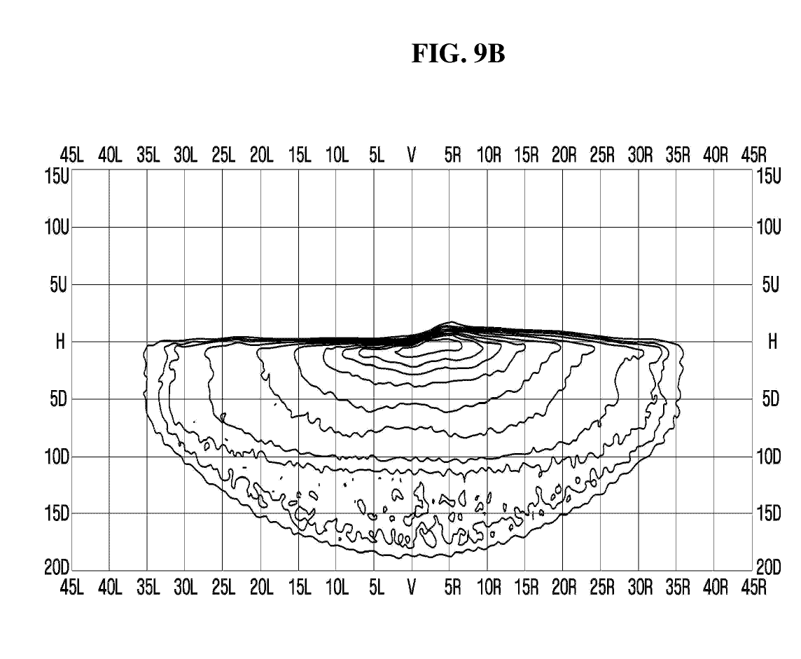

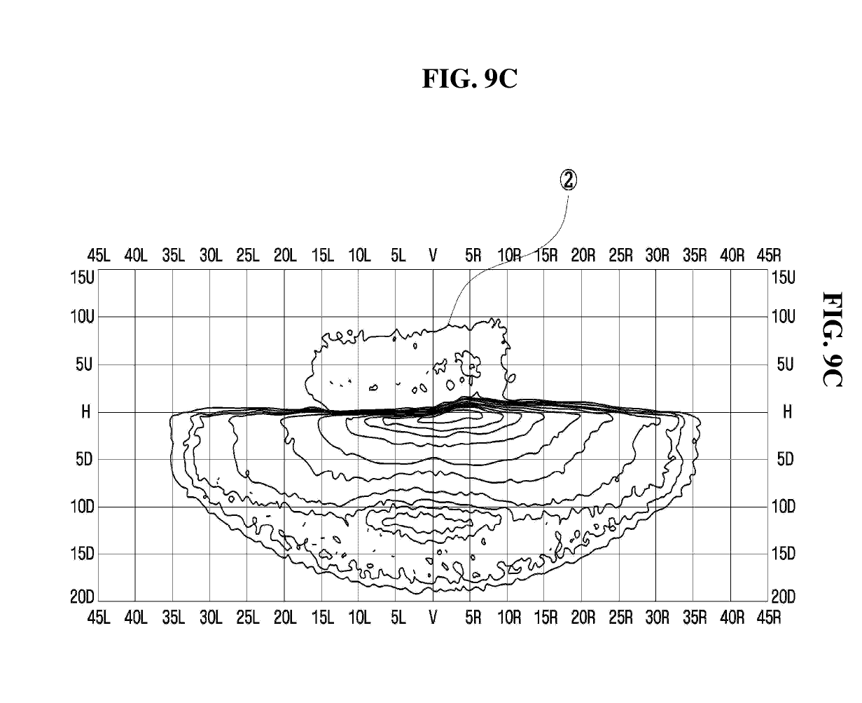

More specifically, FIG. 9A illustrates an initial beam pattern produced when light emitted from the light source 100 is reflected by the reflector 200, condensed in front of the reflector 200, and passes through the aspheric lens 300 to be irradiated in the front lighting direction.

FIG. 9B illustrates a beam pattern produced when the lamp shield 400 shields some of the light emitted from the light source 100. That is, some of the light reflected upward by the reflector 200 is shielded by the lamp shield 400 disposed between the light source 100 and the aspheric lens 300 so that it does not cause discomfort to a driver in an oncoming vehicle traveling in the opposite direction.

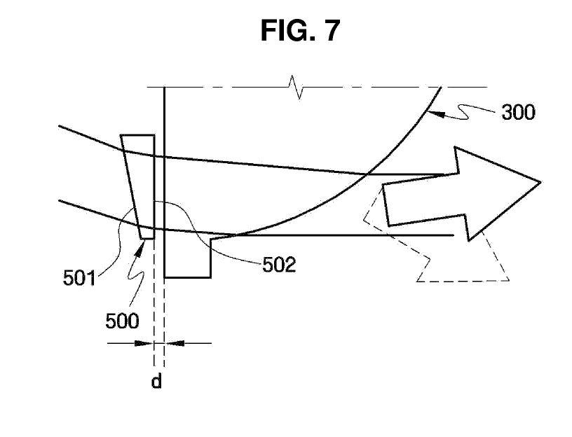

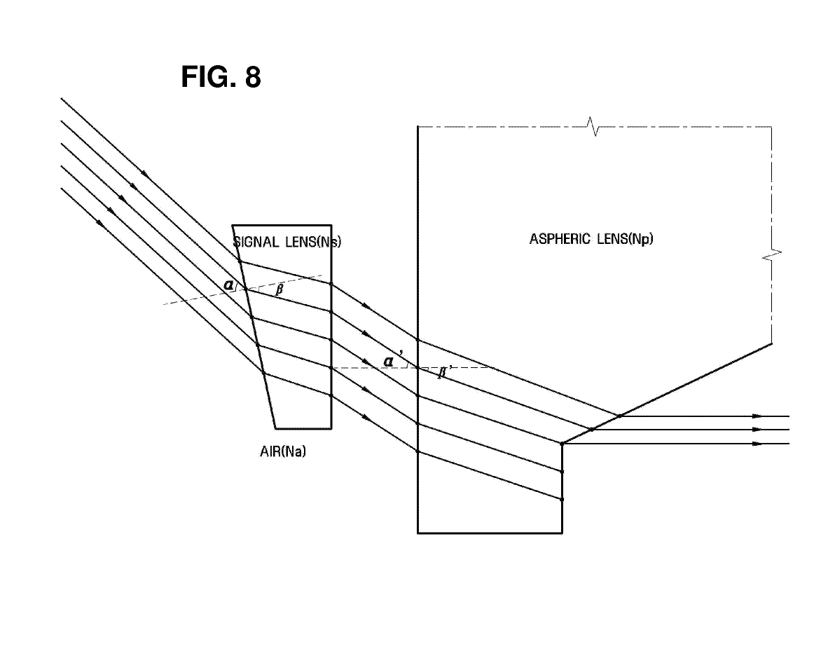

FIG. 9C illustrates a beam pattern when the signal lens 500 is used. More specifically, in the vehicle assembly including the signal lens 500 installed between the lamp shield 400 and the aspheric lens 300, when light emitted from the light source 100 is primarily refracted through the signal lens 500 and secondarily refracted through the aspheric lens 300, the light path is changed so that the light travels upward, as indicated by an arrow in FIG. 7. Refraction occurs when light travels from a medium with a certain refractive index to a medium with another. At the boundary between the two media, the velocity of light is altered according to the difference in refractive index and a light path is changed. Due to refraction, when light passes from a dense medium having a high refractive index N to a sparse medium having a low refractive index N, the angle of refraction is greater than the angle of incidence. Conversely, when light passes from sparse to dense media, the angle of refraction is less than the angle of incidence. A change in the path of light due to a refractive index difference between the ambient air and either the signal lens 500 or the aspheric lens 300 is described briefly with reference to FIG. 8. The signal lens 500 has a refractive index Ns of about 1.47, which is higher than a refractive index Na (=1) of air. Thus, when light travels from a sparse medium, such as air, to a dense medium, such as the signal lens 500, an incidence angle α is less than a refraction angle β so that the light is primarily refracted upward. The light refracted through the signal lens 500 passes through the sparse medium, i.e., the air between the signal lens 500 and the aspheric lens 300, and is incident slightly downward on the aspheric lens 300. In this case, since the aspheric lens 300 has a refractive index Np that is greater than or equal to the refractive index Ns of the signal lens 500, when light travels from the sparse medium (air) to the dense medium (aspheric lens 300), a refraction angle β′ is less than an incidence angle α′ so that the light is secondarily refracted upward. The light then passes through the aspheric lens 300 and is irradiated upward and in front of the vehicle.

Since the light intensity compensator 510 formed on the light incident surface 501 of the signal lens 500 compensates for horizontal intensity of light, as indicated by \textcircled{2} in FIG. 9C, light sequentially passes through the signal lens 500 and the aspheric lens 300 to form a smooth and gentle beam pattern in the horizontal direction. Thus, the vehicle headlamp assembly according to the present embodiment allows easy recognition, when driving at night, of signs ahead and vehicles driving in the opposite direction.

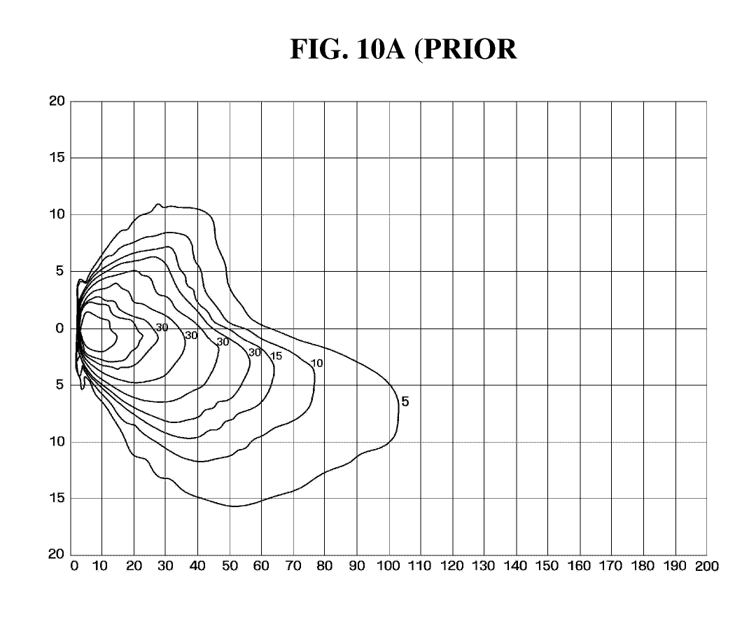

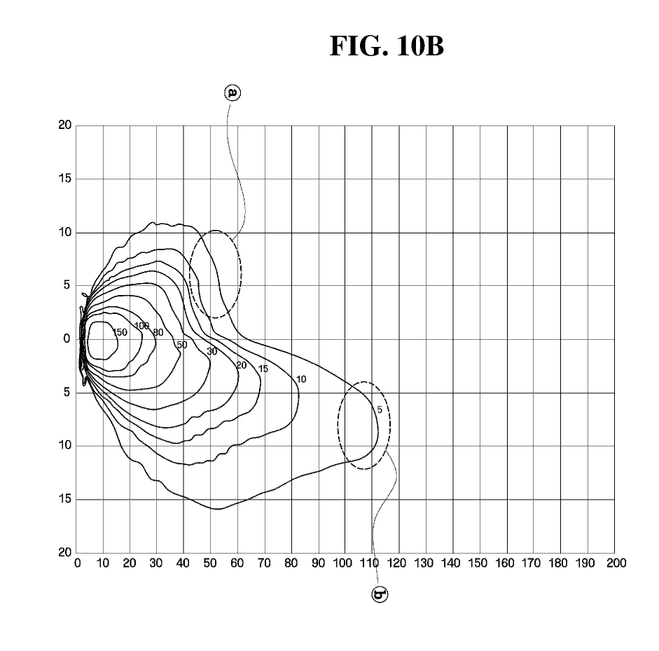

FIGS. 10A and 10B illustrate a comparison of road visibility between a conventional headlamp using a signal plate and a headlamp using a signal lens according to the present invention.

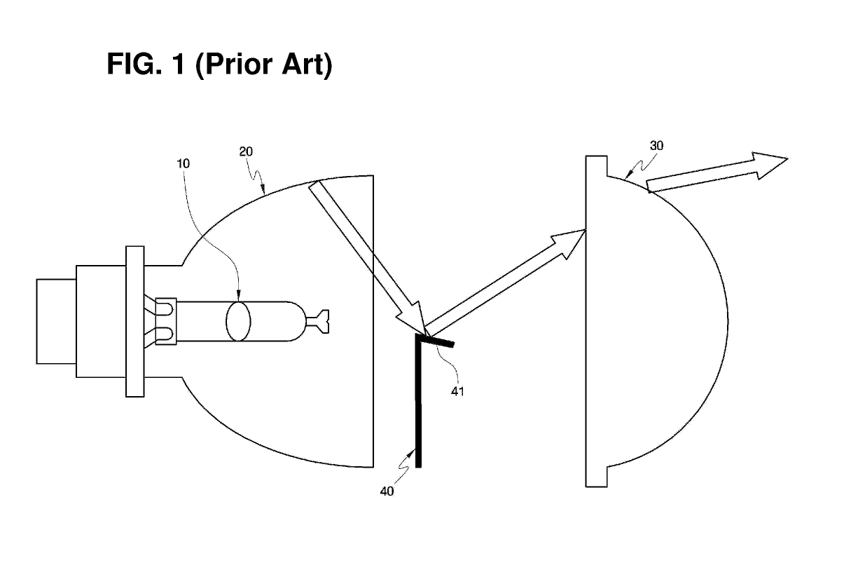

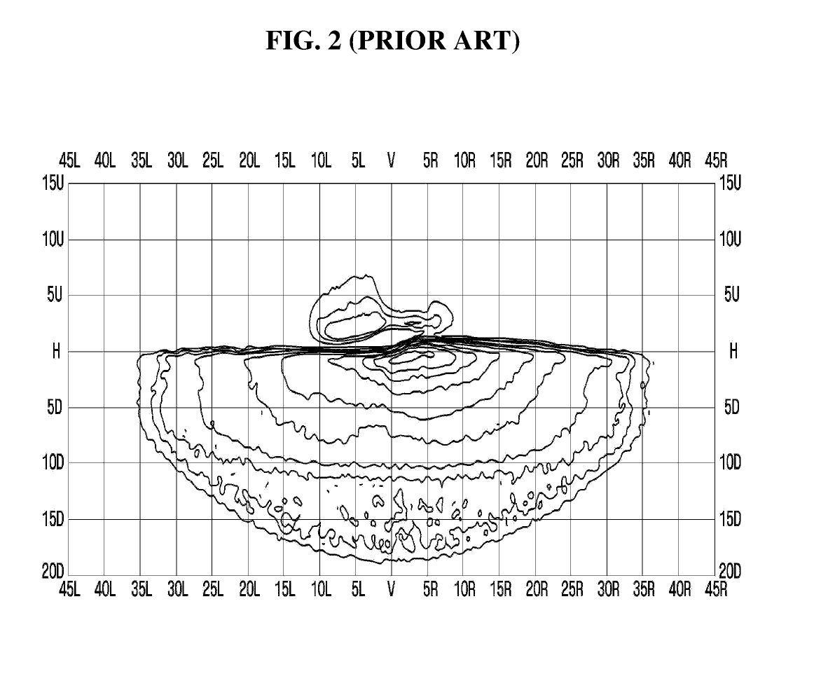

Referring to FIGS. 10A and 10B, a vehicle headlamp assembly according to the present invention uses the signal lens 500 that is installed between the aspheric lens 300 and the lamp shield 400 to double-refract light as it passes sequentially through the signal lens 500 and the aspheric lens 300, thereby exhibiting an increase of about 12% in view of horizontal light intensity, as indicated by \textcircled{a} in FIG. 10B, compared to a conventional headlamp using the signal plate (41 in FIG. 1). In other words, the vehicle headlamp assembly according to the present invention can improve horizontal visibility. The vehicle headlamp assembly according to the present invention also showed an increase of about 9% in forward visibility of a road during nighttime, as indicated by \textcircled{b} in FIG. 10B, compared to the conventional headlamp. In other words, the present invention can provide for improvement in remote-area visibility for nighttime drivers.

Unlike the conventional headlamp having the signal plate 41 fixed to the lamp shield 40, a vehicle headlamp assembly according to the present invention is constructed such that the signal lens 500 is kept at a fixed position between the aspheric lens 300 and the lamp shield 400 regardless of rotation or horizontal movement of the lamp shield 400. Thus, the present invention can meet all signal laws and regulations depending on different beam patterns achieved by an AFLS. Thus, the vehicle lamp assembly according to the present invention can provide a driver with visibility suitable for safe driving in various road and driving conditions, i.e., during high-speed driving requiring a wider view of road in a remote area, during driving in urban areas in which drivers rely less on headlamp illumination due to bright ambient light than other road users, or during driving in bad weather in which light emitted from a headlamp is reflected by rain, snow, or water present on the road surface and causes increased glare and limited visibility in regards to oncoming drivers.

Accordingly, a vehicle headlamp assembly according to the present invention may have one or more of the following advantages.

First, the vehicle headlamp assembly according to the present invention can adaptively change beam patterns according to various road and ambient conditions and provide a driver with visibility suitable for different road conditions, thereby achieving safe driving.

In addition, the vehicle headlamp assembly according to the present invention is so constructed that a signal lens is kept at a fixed position between an aspheric lens and a lamp shield regardless of whether the lamp shield is rotated or horizontally moved, thereby satisfying all signal laws and regulations depending on different beam patterns achieved by an AFLS.

Further, horizontal visibility can be improved by increasing horizontal light intensity, and remote-area visibility for nighttime drivers can be improved by increasing forward visibility of a road surface in front of a vehicle during nighttime.

The effects of the present invention should not be limited to the foregoing description, and additional effects and advantages of the invention will be made more apparent to those skilled in the art from the spirit and scope of the invention as defined by the appended claims.

While the present invention has been particularly shown and described with reference to exemplary embodiments thereof, it will be understood by those of ordinary skill in the art that various changes in form and details may be made therein without departing from the spirit and the scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A lamp assembly comprising:
a light source;
a reflector reflecting and condensing light emitted from the light source;
a first lens refracting and radiating the light emitted from the light source in a forward direction;
a shielding device that is disposed between the light source and the first lens and shields some of the light emitted from the light source; and
a second lens that is disposed between the first lens and the shielding device and changes a light path by refracting light before being incident on the first lens.

2. The assembly of claim 1, wherein some of the light emitted from the light source is reflected by the reflector and then refracted and irradiated upward as it sequentially passes through the second and first lenses.

3. The assembly of claim 1, wherein the second lens is spaced apart from the first lens by a predetermined distance.

4. The assembly of claim 3, wherein the second lens is behind one of upper and lower portions of the first lens.

5. The assembly of claim 1, wherein the second lens is fixedly fitted in a front aperture in a housing having the first lens fitted thereto.

6. The assembly of claim 1, wherein the second lens has a refractive index greater than 1.

7. The assembly of claim 1, wherein the signal lens has a thickness that increases toward the top thereof.

8. The assembly of claim 7, wherein the second lens has a light incident surface inclined downward and a light exit surface parallel to a rear surface of the first lens.

9. The assembly of claim 1, wherein the second lens further comprises a light intensity compensator compensating for the loss of horizontal intensity of light being refracted through the first lens.

10. The assembly of claim 9, wherein the light intensity compensator includes a plurality of curved surfaces with different radii of curvature, which are formed in a center of the light incident surface of the signal lens.

11. The assembly of claim 10, wherein the plurality of curved surfaces have different radii of curvature depending on the degree of compensation for horizontal light intensity.

12. The assembly of claim 10, wherein the plurality of curved surfaces are horizontally or vertically parallel to one another.
